(19) United States
(12) Patent Application Publication
(10) Pub. No.: US 2004/0179029 A1
(43) Pub. Date: Sep. 16, 2004

(54) Display device

(76) Inventors: Yoshinori Ogawa, Yamatotakada-shi (JP); Shigeki Tanaka, Nara-shi (JP)

Correspondence Address: HARNESS, DICKEY & PIERCE, P.L.C., P.O. BOX 8910, RESTON, VA, 20195, US

(21) Appl. No.: 10/797,000

(22) Filed: Mar. 11, 2004

(30) Foreign Application Priority Data
Mar. 12, 2003 (JP) 2003-067210

(51) Int. Cl. G09G 5/10

(52) U.S. Cl. 345/690

(57) ABSTRACT

A display device includes a display panel including a plurality of pixels provided in matrix; a source driver for sequentially driving, in a vertical direction, each pixel line provided along a horizontal direction, the source driver causing the display panel to display an image that is in accordance with display data; gradation display reference voltage generating circuits for generating reference voltages that represent multiple gradations, the reference voltages being used for displaying the image in the multiple gradations; a γ-correction adjustment section for adjusting the reference voltages so as to perform γ-correction of the display data; and a control section for controlling the γ-correction adjustment section so as to change the reference voltages on which the γ-correction has been performed, the control section decreasing display unevenness between pixels that are adjacent to one another. The display device can have a large display screen and can prevent cost increase.

This nonprovisional application claims priority under 35 U.S.C. § 119(a) on Patent Application No. 2003/067210 filed in Japan on Mar. 12, 2003, the entire contents of which are hereby incorporated by reference.

### FIELD OF THE INVENTION

The present invention relates to a display device, e.g. an active matrix liquid crystal display device, that is improved in terms of display unevenness and other problems, and that is excellent in display quality.

### BACKGROUND OF THE INVENTION

An active matrix liquid crystal display device includes a thin-film transistor (hereinafter “TFT”) panel and an opposed panel. The TFT panel and the opposed panel are provided in an overlapping manner, and are bonded together by a frame-shaped seal material. The TFT panel and the opposed panel constitute a liquid crystal cell. Inside the liquid crystal cell, liquid crystal is sealed.

The TFT panel is a transparent substrate (e.g. a glass substrate) on which a plurality of transparent pixel electrodes, a plurality of gate lines, and a plurality of source lines are provided. The plurality of transparent pixel electrodes are arranged lengthwise and breadthwise. The plurality of gate lines supply gate signals to a plurality of TFTs that correspond to the plurality of pixel electrodes. The plurality of source lines supply data signals to the plurality of TFTs. The opposed panel is a transparent substrate (e.g. a glass substrate) on which there are provided transparent opposed electrodes (electrodes having light transmittance). The transparent opposed electrodes face all the pixel electrodes on the TFT panel.

For example, the TFTs are generally manufactured by a thin-film formation technology, i.e. a photofabrication technology. A process of forming a thin-film pattern of the TFTs is as follows: (1) A thin film made of a thin-film material is formed on a substrate by a predetermined film-forming method (e.g. a spattering method, a CVD method, or the like); and (2) The thin film is shaped into a desired pattern by a so-called PEP (a photo-etching process).

The thin film formed on the substrate is coated with photoresist. Then, the photoresist is exposed so that the photoresist is shaped into the desired pattern. Specifically, a photomask having a light shielding body of the desired pattern is set at an adjusted position above the substrate. Then, light is radiated onto the photoresist from above via the photomask, so as to expose the photoresist.

Next, the exposed photoresist is developed. Then, unnecessary parts of the thin film formed on the substrate are removed by etching by using the developed photoresist as a mask. In this way, the desired pattern is formed. The foregoing process is repeated as many times as the number of layers of the thin-film, which constitutes the electrodes and semiconductor elements. As a result, desired elements are manufactured.

Recently, there are increasing needs for a large-screen liquid crystal display device. Therefore, the number of optical elements (typically liquid crystal display elements) is becoming increasingly large. In view of the circumstance, there are needs for a thin-film formation technology and a patterning technology that are suitable for display elements having large areas.

In the exposure, an area that can be exposed at once is limited. This is because there is a certain limit on a capability of an optical system of an exposing device. To overcome this problem, as the thin-film formation technology and the patterning technology that are suitable for display elements having large areas, a divisional exposure (so-called stepper) method is employed in order to expose a large area.

In the divisional exposure method using a stepper, as shown in FIG. 12 for example, a substrate 60, which is to be exposed, is divided into a plurality of regions (e.g. four exposure regions a, b, c, and d) along a surface direction of the substrate 60. In each exposure (shot), one of the exposure regions is exposed, and this process is repeated (step and repeat) as many times as the number of exposure regions, until an entire surface of the substrate 60 is exposed. In this way, it is possible to expose a large area that is larger than an area that can be exposed at once by the exposing device.

In one well-known manufacturing method, a large-scale liquid crystal display device is manufactured as described above by (1) forming a large TFT panel and a large opposed panel from large substrates (glass substrates), and (2) bonding together the TFT panel and the opposed panel. In another well-known manufacturing method, a large-scale liquid crystal display device is manufactured as described above by (1) forming a plurality of small liquid crystal elements, each of which is made of a TFT panel and an opposed panel that are bonded together, and (2) Jointing the plurality of small liquid crystal elements on the same plane.

However, in case a large-screen liquid crystal display device is manufactured by (1) forming a large TFT panel and a large opposed panel from large substrates, and (2) bonding together the TFT panel and the large opposed panel, there are the following problems. It is not particularly problematic that the opposed panel is large as a whole, because the opposed electrodes may be formed on a substantially entire region of the substrate. However, the TFT panel has a complex structure in that (i) a large number of TFTs, (ii) a large number of pixel electrodes that correspond to the large number of TFTs, (iii) a large number of gate lines, and (iv) a large number of data lines are provided on the substrate. Therefore, if the substrate is large, display quality is deteriorated by problems such as distortion and contortion. As a result, it is likely that deficiencies occur, such as display unevenness.

On the other hand, if a large-screen liquid crystal display device is manufactured by jointing a plurality of small liquid crystal elements, joint lines between the small liquid crystal elements are visible on the screen. This is visually disadvantageous.

Thus, the active matrix liquid crystal display device manufactured by the stepper method has a problem that, even though mutually different exposure regions 68 receive identical image signals, pixels 71 respond to the identical image signals with different luminance from region to region (see FIGS. 13 and 14).

In particular, if luminance of pixels 71 is significantly different between adjacent ones of the exposure regions 68, borderline parts 69 between the adjacent ones of the exposure areas 68 are visually recognized as joint lines on a display screen. This drastically deteriorates display quality of the active matrix liquid crystal display device, which requires high-definition image display.

An arrangement for overcoming this drawback is disclosed in WO95/16276 (publication date: Jun. 15, 1995; corresponding to U.S. Pat. No. 5,656,526 and U.S. Pat. No. 5,784,135). In this arrangement, a display element (e.g. a liquid crystal display element) is manufactured by (1) dividing a display element into a plurality of regions, and (2) performing exposure of photoresist or the like processing, so as to form an arrayed pattern of unit pixels. In this process, in case luminance is different between adjacent ones of the plurality of regions (small regions) created by division, borderlines between the adjacent ones of the plurality of regions are designed to be non-linear (zigzag). In this way, luminance in one region and luminance in another region do not make a significant contrast in a vicinity of the borderlines. As a result, the joint lines between the display regions become less visible.

According to the arrangement described in WO95/16276, the borderlines between adjacent ones of the plurality of display regions (small region), the adjacent ones having different luminance, are designed to be non-linear (zigzag), so that the joint lines between the display regions are less visible.

However, in the arrangement of WO95/16276, the borderlines, at which the display regions are bonded together, are designed to be a complex non-linear (zigzag) shape. Therefore, it is difficult to manufacture the borderlines with high accuracy. As a result, there is a problem that yield is lowered, and costs are increased.

### SUMMARY OF THE INVENTION

The present invention was made to solve the foregoing problems. An object of the present invention is therefore to provide a liquid crystal display device that can have a large screen and that can perform clear display by γ-correction, which is generally performed so as to adjust luminance of pixels. In the present invention, a γ-correction value is increased or decreased from a reference value so that display unevenness is decreased by the γ-correction. In this way, it is possible to prevent display unevenness without requiring a step of generating a complex-shape borderline on a liquid crystal panel. Therefore, it is possible to provide a liquid crystal display device that can have a large screen and that can perform clear display by preventing a conventional visual disadvantage of a joint line.

In order to attain the foregoing object, a display device of the present invention includes: a display panel including a plurality of pixels provided in matrix in a first direction and in a second direction, the second direction intersecting with the first direction; a driving section for sequentially driving, in the second direction, each pixel line provided along the first direction, the driving section causing the display panel to display an image that is in accordance with display data; a reference voltage generating section for generating reference voltages that represent multiple gradations, the reference voltages being used for displaying the image in the multiple gradations; a γ-correction adjustment section for adjusting the reference voltages so as to perform γ-correction of the display data; and a control section for controlling the γ-correction adjustment section so as to change the reference voltages on which the γ-correction has been performed, the control section decreasing display unevenness between pixels that are adjacent to one another in at least one of the first and the second directions.

With this arrangement, by using the display panel, the driving section, the reference voltage generating section, and the γ-correction adjustment section, it is possible to display an image that matches a visual characteristic as a result of the γ-correction and that is expressed with gradations.

In the foregoing arrangement, the display device further includes the control section for controlling the γ-correction adjustment section so as to change the reference voltages on which the γ-correction has been performed. Therefore, even if there is display unevenness among pixels for reasons such as uneven quality of the pixels, the uneven quality deriving from a manufacturing process, it is possible to make the display unevenness less visible by changing the reference voltages.

In other words, according to the foregoing arrangement, it is possible to make the display unevenness less visible by changing the reference voltages, even if (i) the display panel is, for example, a large display panel made by bonding together a plurality of display panels so that display surfaces of the plurality of display panels are on the same plane, and (ii) display unevenness, such as uneven luminance, is generated due to uneven quality among the plurality of display panels, the uneven quality deriving from a manufacturing process.

Therefore, according to the foregoing arrangement, it is possible to decrease display unevenness, thereby preventing the visual disadvantage of conventional displays that joint lines are visible. This is achieved without requiring a conventional step of generating a complex-shape borderline on a liquid crystal panel. As a result, according to the foregoing arrangement, it is possible to provide a liquid crystal display device that can have a large screen and that can perform clear display. In addition, because the foregoing arrangement does not require the conventional step of generating a complex-shape borderline on a liquid crystal panel, it is possible to prevent cost increase.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a block diagram illustrating a schematic arrangement of a source driver that belongs to a liquid crystal display device of one embodiment of the present invention.

FIG. 2 is a schematic block diagram illustrating the liquid crystal display device.

FIG. 3 is a circuit diagram illustrating a schematic arrangement of a display panel of the liquid crystal display device.

FIG. 4 is a waveform chart illustrating one example of a liquid crystal driving waveform in the liquid crystal display device.

FIG. 5 is a waveform chart illustrating another example of a liquid crystal driving waveform in the liquid crystal display device.

FIG. 6 is a block diagram illustrating a schematic arrangement of a reference voltage generating circuit provided in the source driver.

FIG. 7 is a block diagram illustrating one example of how each source driver operates in order to perform γ-correction with respect to a borderline part (a joint part).

FIG. 8 is a schematic block diagram illustrating a γ-correction adjustment circuit of the reference voltage generating circuit.

FIG. 9(a) and FIG. 9(b) are block diagrams illustrating one example of how the γ-correction adjustment circuit operates. FIG. 9(a) illustrates a case in which an output voltage Vout is higher than a reference voltage Vref, and FIG. 9(b) illustrates a case in which the output voltage Vout is lower than the reference voltage Vref.

FIG. 10 is a circuit diagram illustrating a schematic arrangement of a D/A converter circuit of the liquid crystal display device.

FIG. 11 is a circuit diagram of the γ-correction adjustment circuit.

FIG. 12 is a conceptual diagram illustrating a manufacturing step for the liquid crystal display device. In this step, a large substrate is divided into a plurality of shot regions, and exposure (shot) is performed with respect to each shot region.

FIG. 13 is a plan view of a dot pattern in each shot region.

FIG. 14 is an enlarged plan view of the dot pattern in FIG. 13.

### DESCRIPTION OF THE EMBODIMENTS

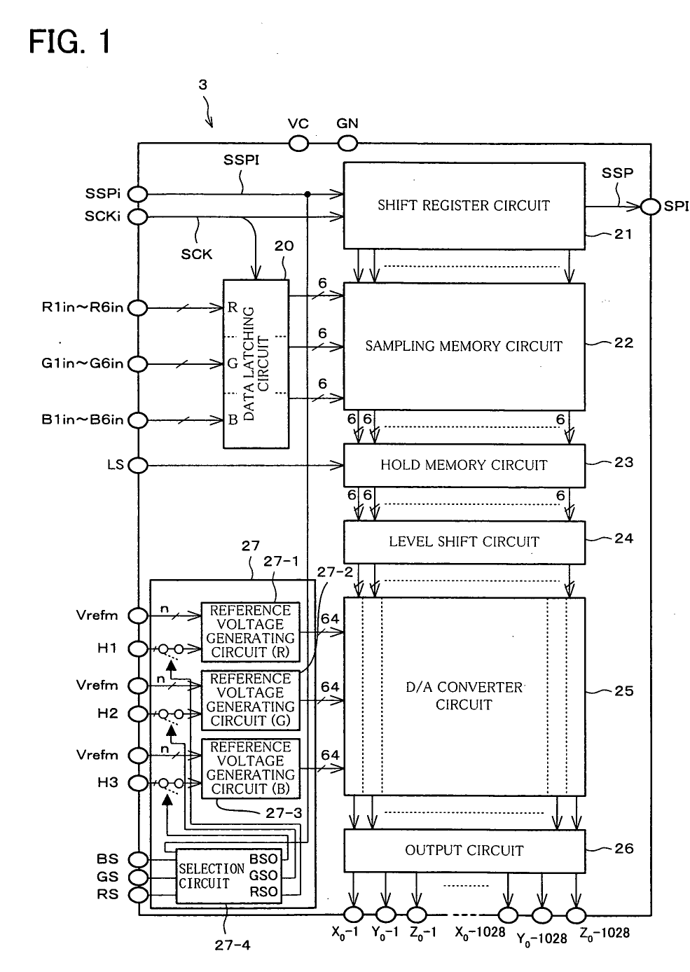

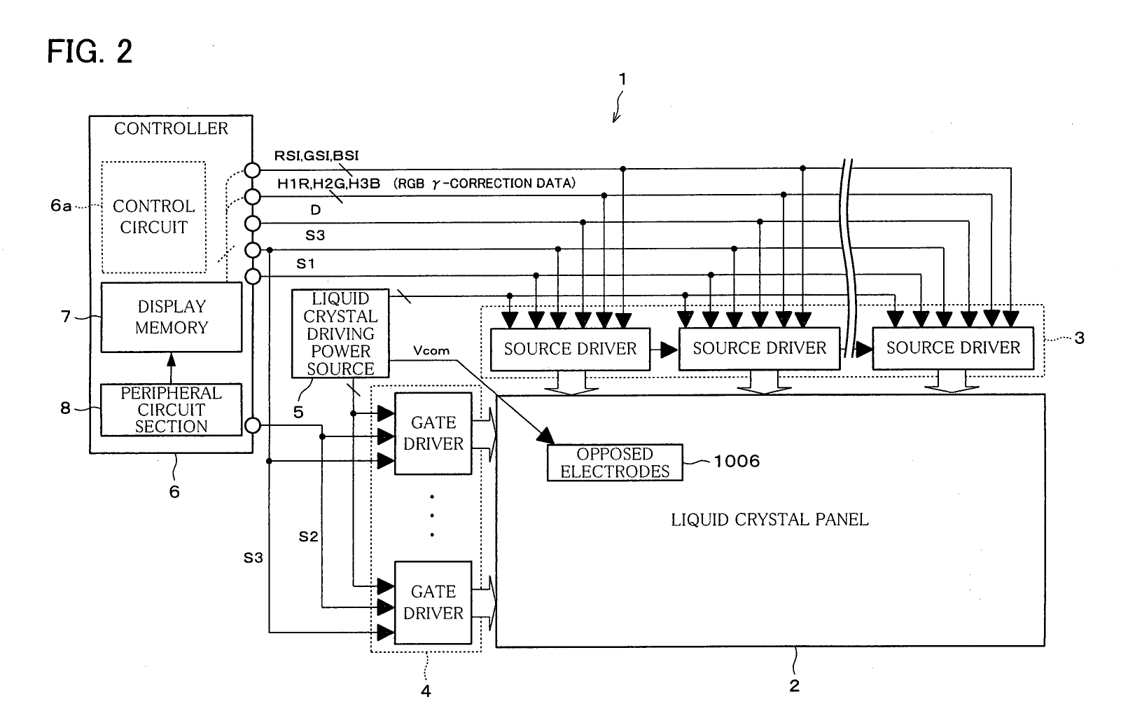

With reference to FIGS. 1 to 11, the following describes a liquid crystal display device as one embodiment of a display device of the present invention. FIG. 2 is a block diagram illustrating an arrangement of a TFT liquid crystal module as the liquid crystal display device of the present embodiment. In FIG. 2, only principal constituents and principal signal pathways are illustrated. Therefore, for example, signal pathways for the other signals, such as clock signals, reset signals, and select signals, are omitted.

As shown in FIG. 2, a display device (a TFT liquid crystal module) 1 of the present embodiment includes a liquid crystal panel (a display panel) 2, source drivers (a driving section) 3, gate drivers 4, a liquid crystal power source 5, and a controller (a control section) 6.

The liquid crystal panel 2 is a liquid crystal panel on which TFT-type pixels are provided in matrix of m-number of pixels in a horizontal direction (a first direction) and n-number of pixels in a vertical direction (a second direction). The pixels are made of m-number of source electrodes and n-number of gate electrodes. In the present embodiment, the horizontal direction and the vertical direction perpendicularly intersect with one another. However, intersecting perpendicularly is not a necessary condition, as long as the horizontal direction and the vertical direction intersect with one another.

In the following, one line of pixels in the horizontal direction is called “a row”, and one line of pixels in the vertical direction is called “a column”. In the present embodiment, m=128×RGB, and n=900, for example. Each pixel displays 64 gradations (6 bit) ranging from a 0th gradation to a 63rd gradation. However, the number of gradations and the number of pixels may be changed according to needs.

In each row, pixels respectively for displaying R(red), G(green), and B(blue) are provided in repeated fashion. That is, in each row, pixels of R, G, and B are provided in this order in repeated fashion. Therefore, each row includes n-number of pixels of R, n-number of pixels of G, and n-number of pixels of B.

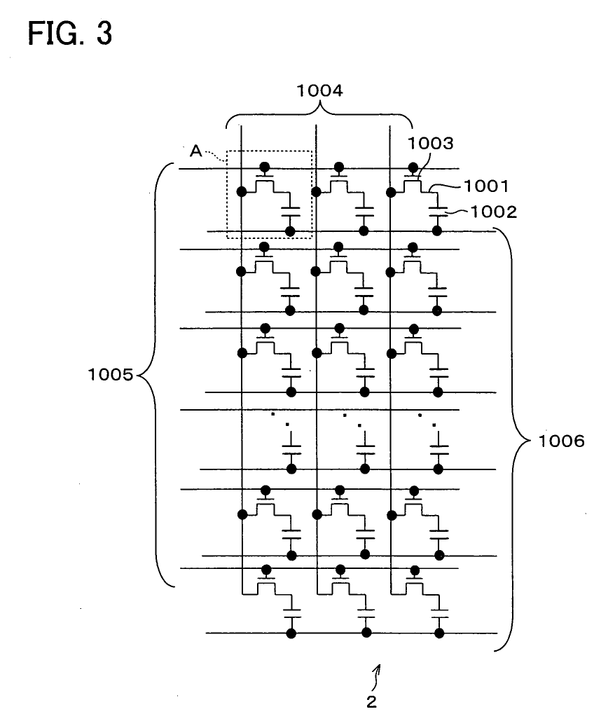

As shown in FIG. 3, the liquid crystal panel 2 is provided with pixel electrodes 1001, pixel capacitors 1002, TFTs 1003, source signal lines 1004, gate signal lines 1005, and opposed electrodes 1006. The TFTs 1003 are switching elements for turning ON/OFF a voltage supply to the pixels. In FIG. 3, the region denoted by A (the region surrounded by dotted lines) is a liquid crystal element of one pixel.

To the source signal lines 1004, the source drivers 3 supply gradation display voltages. The gradation display voltages are indicative of brightness of those pixels that are to perform display. The brightness is in accordance with the display data. To the gate signal lines 1005, the gate drivers 4 supply scanning signals so as to sequentially turn ON the TFTs 1003 aligned in the vertical direction. Through a TFT 1003 in an ON-state, a voltage of a source signal line 1004 is supplied to a pixel electrode 1001 connected to a drain of the TFT 1003. A pixel capacitor 1002 provided between the pixel electrode 1001 and an opposed electrode 1006 is charged with an electric charge that is in accordance with the voltage supplied. With this arrangement, light transmittance of liquid crystal of a liquid display element changes in accordance with the voltage supplied. In this way, the liquid crystal display panel 2 performs gradation display.

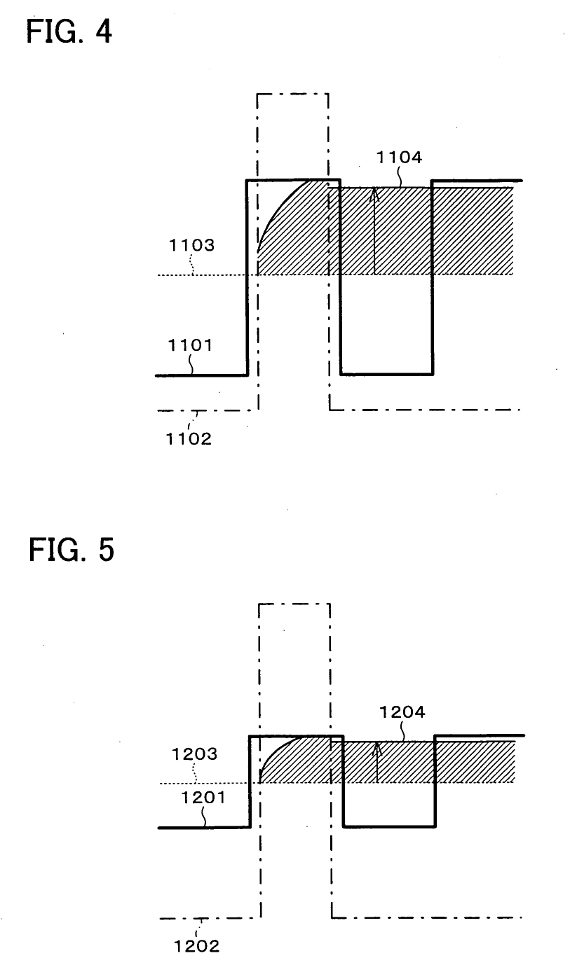

FIGS. 4 and 5 illustrate examples of liquid crystal driving waveforms for driving liquid crystal elements of the liquid crystal panel 2. In FIGS. 4 and 5, 1101 and 1201 are driving waveforms of output signals from the source drivers 3; 1102 and 1202 are driving waveforms of output signals from the source driver 4; 1103 and 1203 are voltages of the opposed electrodes; and 1104 and 1204 are voltage waveforms of the pixel electrodes. A voltage supplied to a liquid crystal material is a voltage difference between a pixel electrode 1001 and an opposed electrode 1006, and is indicated by shaded areas in FIGS. 4 and 5.

For example, in FIG. 4, a TFT 1003 turns ON when the output signal represented by the driving waveform 1002 is HIGH, the output signal being supplied from a gate driver 4. Then, a difference between (i) the output signal represented by the driving waveform 1101, the output signal being supplied from the source drivers 3, and (ii) the voltage 1003 of the opposed electrode 1006 is supplied to a pixel electrode 1001. After that, as indicated by 1102, the output signal from the gate driver 4 becomes LOW, and the TFT 103 turns OFF. At this time, because the pixel capacitor 1002 is provided, the voltage is maintained in the pixel. The description above regarding FIG. 4 also applies to FIG. 5.

FIG. 4 and FIG. 5 are different in terms of the voltage supplied to the liquid crystal material. In FIG. 5, the voltage supplied is lower than the voltage supplied in FIG. 5. Thus, in the present embodiment, multi-gradation display is attained by changing the light transmittance of the liquid crystal in an analog manner. This is achieved by changing, as an analog voltage, the voltage supplied to the liquid crystal. The number of gradations that can be displayed is determined according to the number of choices for the analog voltage supplied to the liquid crystal.

As shown in FIG. 2, the controller 6 includes a display memory 7. The display memory 7 is not particularly limited, but is designed to be capable of storing (i) display data (e.g. data for displaying a still image or data for displaying characters) for m (in the horizontal direction)×n (in the vertical direction) number of pixels, and (ii) plural sets of γ-correction adjustment data. The plural sets of γ-correction adjustment data are described later. In the present embodiment, the display memory 7 is contained in the controller 6. However, this arrangement is only one example; the display memory 7 may be contained in the source drivers 3 (not shown).

It is needless to say that memory array of the display memory 7 includes a nonvolatile memory such as flash memory, an OTP, an EEPROM, an FeRAM (a ferroelectric memory), or the like. The memory array is not limited to that of a particular kind. Once data such as the plural sets of γ-correction adjustment data is stored in the display memory 7, the data is kept even after power supply is shut down.

The controller 6 includes not only the display memory 7, but also a peripheral circuit section 8 and a control circuit 6a. The control circuit 6a supplies (i) display data D and (ii) control signals S1, such as a horizontal synchronization signal, a transfer clock, and a start pulse input signal, to the source drivers 3. To the gate driver 4, the control circuit 6a supplies control signals S2 such as a vertical synchronization signal and the horizontal synchronization signal. Furthermore, the control circuit 6a supplies the horizontal synchronization signal S3 to the source drivers 3 and to the gate drivers 4, respectively.

According to the foregoing arrangement, display data supplied from outside is supplied to the source drivers 3 via the controller 6, the display data being the display data D (R, G, and B), which is a digital signal.

After that, the source drivers 3 perform time division of the display data D supplied, and respectively latches divided data into the plurality of source drivers 3. Then, in synchronization with the horizontal synchronization signal S3 supplied from the controller 6, the source drivers 3 perform D/A conversion (selects gradation display reference voltages in accordance with the digital display data). The plurality of source drivers 3 respectively correspond to a plurality of regions of the liquid crystal panel 2, the plurality of regions being aligned in the horizontal direction with no space between adjacent ones of the plurality of regions.

Then, the source drivers 3 supply gradation display analog voltages (hereinafter “gradation display reference voltages”) via the source signal lines 1004 to the corresponding liquid crystal elements of the display panel 2, respectively. The gradation display reference voltages are made by the D/A conversion of the display data D that is divided by time division.

The peripheral circuit section 8 includes members not shown in the figure, namely an input/output circuit, a Y-address generating circuit, a Y-decoder, an X-address generating circuit, and an X-decoder. The Y-address generating circuit generates a Y-address. The Y-decoder supplies a decode signal in accordance with address data supplied from the Y-address generating circuit. The X-address generating circuit generates an X-address. The X-decoder supplies a k-bit decode signal in accordance with address data supplied from the X-address generating circuit. In accordance with the decode signals, the peripheral circuit section 8 controls, for example, writing into the display memory 7 and reading from the display memory 7.

FIG. 1 illustrates one example of a block diagram of an arrangement of a source driver 3. As shown in FIG. 1, the source driver 3 includes a data latching circuit 20, a shift register circuit 21, a sampling memory circuit 22, a hold memory circuit 23, a level shift circuit 24, a D/A converter circuit 25, an output circuit 26, and gradation display reference voltage generating circuits (a reference voltage generating section) 27.

The following describes operation of the source driver 3. The shift register circuit 21 is a circuit that shifts (i.e. transfers) a start pulse input signal SSPI. The start pulse input signal SSPI is a signal supplied from the controller 6 to an input terminal SSPi of the source driver 3, and is synchronized with the horizontal synchronization signal of display data of R, G, and B.

The start pulse input signal SSPI is supplied from the controller 6, and is shifted by a clock signal SCK supplied to an input terminal SCKi of the source driver 3. If, for example, the number of the source drivers 3 is eight, the start pulse input signal SSPI shifted by the shift register circuit 21 is sequentially transferred from a first source driver 3, which is a first-stage source driver 3, to an eighth source driver 3, which is an eighth-stage source driver 3.

Meanwhile, from terminals R1 to R6 of the controller 6, 6-bit display data signals for R are outputted. From terminals G1 to G6 of the controller 6, 6-bit display data signals for G are outputted. From terminals B 1 to B6 of the controller 6, 6-bit display data signals for B are outputted. The display data signals are synchronized with a rise of clock signal/SCK (an inversion signal of the clock signal SCK), and are serially supplied to input terminals R1in to R6in, input terminals G1in to G6 in, and input terminals B1in to B6in, respectively. The display data signals thus supplied serially are temporarily latched in the data latching circuit 20, and transferred to the sampling memory circuit 22.

The sampling memory circuit 22 performs sampling of the display data signals (18 bit; a sum of R, G, and B, each of which is 6 bit) supplied by time division from output stages of the shift register circuit 21. The sampling memory circuit 22 keeps storing the display data signals until a latch signal LS supplied from a terminal of the controller 6 to the hold memory circuit 23 is supplied to a terminal LS of the source driver 3.

To the hold memory circuit 23, RGB display data signals for one horizontal period are sequentially supplied from the sampling memory circuit 22. The hold memory circuit 23 stores the data signals for one horizontal period until supply of the data signals for one horizontal period is completed. Then, the hold memory circuit 23 supplies the data signals for one horizontal period to the level shift circuit 24.

As described later, the gradation display reference voltage generating circuits 27 generate 64 patterns of reference voltages for gradation display, and respectively supply the reference voltages to liquid crystal driving voltage output terminals for R, G, and B. The gradation display reference voltage generating circuits 27 include an R-use reference voltage generating circuit 27-1, a G-use reference voltage generating circuit 27-2, and a B-use reference voltage generating circuit 27-3, which are provided respectively for three principal colors for color display. In addition, the gradation display reference voltage generating circuits 27 include a selecting circuit 27-4.

To a terminal Vrefm connected to the gradation display reference voltage generating circuits 27, a highest reference voltage supplied from an external liquid crystal driving power source 5 shown in FIG. 2 is supplied. Terminals H1, H2, and H3 are connected to the display memory 7 contained in the controller 6. To the terminals H1, H2, and H3, γ-correction adjustment data H1R, H2G, and H3G stored in the display memory 7 are supplied.

Terminals RS, GS, and BS connected to the selecting circuit 27-4 are connected to the controller 6. In accordance with input signals RSI, GSI, and BSI, and the start pulse input signal SSPI, which are supplied from the controller 6, the selecting circuit 27-4 generates control signals for controlling conduction/non-conduction, and outputs the control signals as control signals RSO, GSO, and BSO.

The control signals RSO, GSO, and BSO from the selecting circuit 27-4 cause analog switches to be conductive or non-conductive. The analog switches are respectively connected between (i) the terminals H1, H2, and H3, and (ii) the R-use reference voltage generating circuit 27-1, the G-use reference voltage generating circuit 27-2, and B-use reference voltage generating circuit 27-3. When the analog switches are conductive, the γ-correction adjustment data H1R, H2G, and H3G are respectively supplied to the R-use reference voltage generating circuit 27-1, the G-use reference voltage generating circuit 27-2, and B-use reference voltage generating circuit 27-3. With this arrangement, it is possible to change a γ-correction value independently with respect to each source driver 3 and with respect to each color.

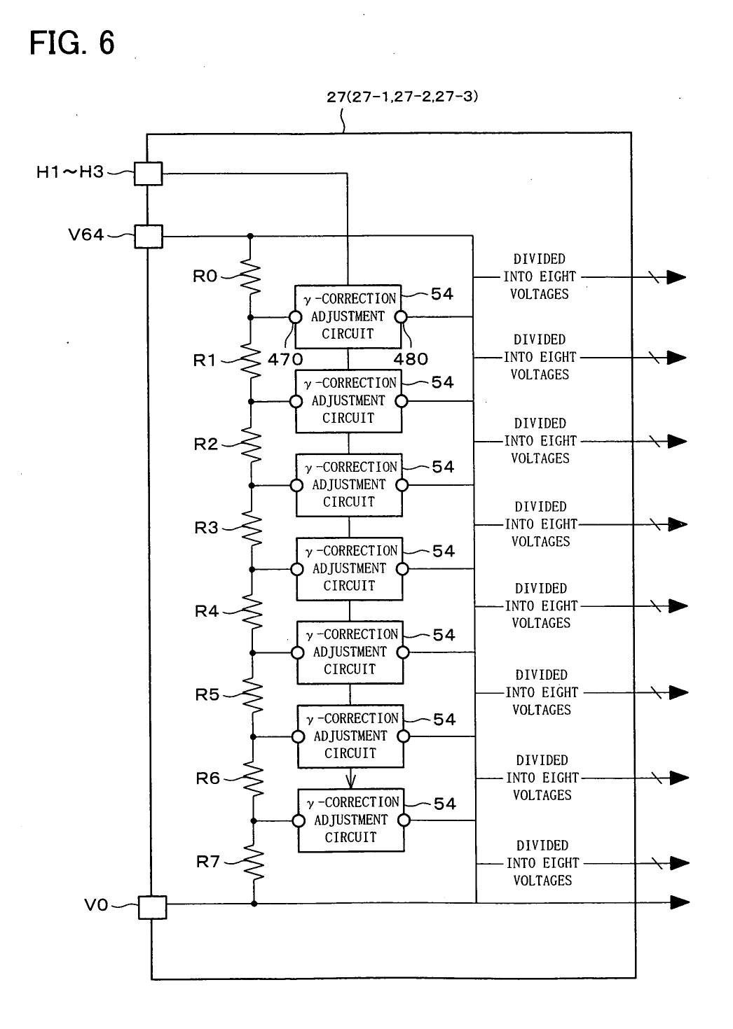

Although not shown in FIG. 6, the gradation display reference voltage generating circuit 27 includes latching circuits for respectively storing signals H1 to H3, which are the γ-correction adjustment data.

The analog switches are controlled by a signal received from the selecting circuit 27-4, the signal received from the selecting circuit 27-4 being in synchronization with the start pulse input signal SSPI (e.g. in synchronization with a timing at which the source driver 3 receives the start pulse input signal SSPI). By this control, desired γ-correction adjustment data is received, and stored in the latching circuits. Thereafter, as shown in FIG. 6, the adjustment data contained is used in order to cause γ-correction adjustment circuits 54 to operate.

Meanwhile, the γ-correction adjustment data is read out of the display memory 7 at a timing at which the start pulse input signal SSPI is transferred to the next source driver 3. Therefore, the peripheral circuit section 8 is provided with judging means (e.g. a counter circuit for counting the number of transfer clocks) for judging a timing at which the start pulse input signal SSPI is transferred from an i-th source driver 3 to a next (i+1)-th source driver 3.

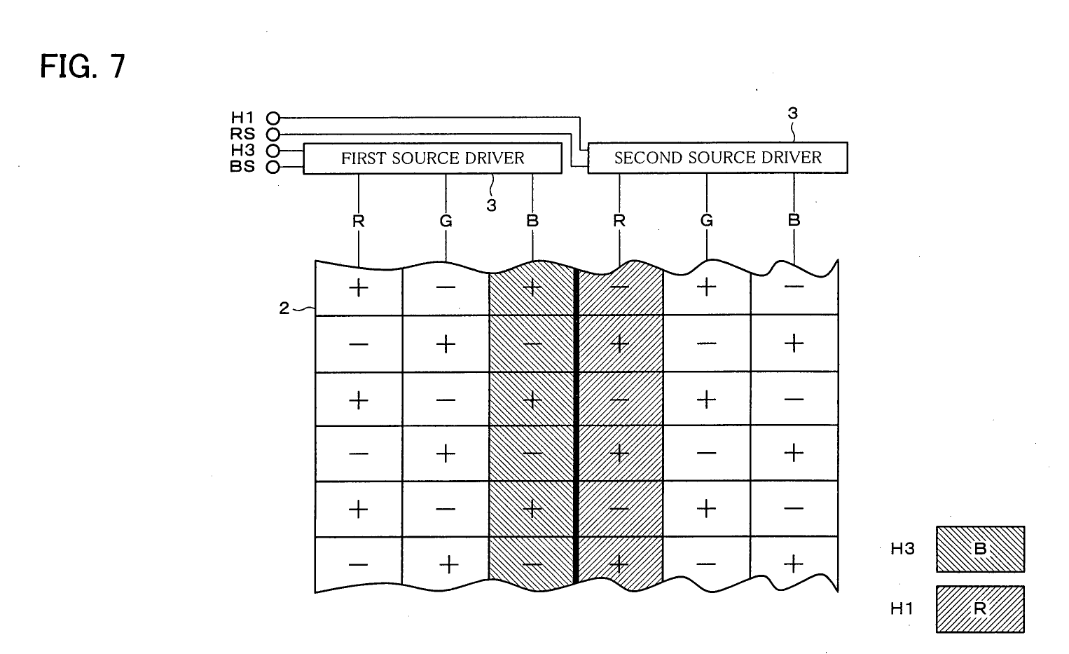

In the present embodiment, a γ-correction value is adjusted with respect to each source driver 3. The adjustment is executed with respect to display regions that are adjacent to one another and that are divided by a borderline shown by the vertical bold line at a center of FIG. 7. The adjustment is also executed with respect to display regions that reflect differences between output characteristics of the source drivers 3. By thus adjusting the γ-correction value independently with respect to R, G, and B, display quality is improved even if mutually adjacent pixel columns are subjected to different exposure and therefore have different characteristics (see the region on the left of the bold line in FIG. 7), as in a case in which a stepper is used. By repeating the above-described data exchanges with respect to each horizontal synchronization period, desired display operation is attained.

The γ-correction value can be adjusted (changed) by adjusting luminance data of specific coordinates (i.e. coordinates of small regions divided by the border line) of the display data on the display memory 7 of the controller 6 in such a manner as to reduce a difference in luminance between, for example, the display regions that are adjacent to one another and that are divided by the borderline.

As shown in FIG. 1, the D/A converter circuit 25 converts, into analog signals, the display data that is supplied from the hold memory circuit 23 and that is converted by the level shift circuit 24. The display data are RGB digital signals each of which is 6 bit. The conversion by the D/A converter is performed in accordance with the 64 patterns of reference voltages.

The output circuit 26 amplifies the 64 levels of analog signals, and supplies the analog signals as gradation display voltages to the display panel 2 via output terminals Xo-1 to Xo-1028, Yo-1 to Yo-1028, and Zo-1 to Zo-1028. The number of the output terminals Xo-1 to Xo-1028 is 1028; the numbers of the output terminals Yo-1 to Yo-1028 and output terminals Zo-1 to Zo-1028 are also 1028. A terminal VC of the source driver 3 and a terminal GN of the source driver 3 are connected to the liquid crystal driving power source 5, and are respectively supplied with a line voltage and a ground potential.

FIG. 6 illustrates a typical example of one of the three reference voltage generating circuits (27-1 for R, 27-2 for G, and 27-3 for B) of the present embodiment, the three reference voltage generating circuits being for gradation display. The gradation display reference voltage generating circuits 27 generate the 64 patterns of reference voltages in order to produce an intermediate voltage. However, the gradation display reference voltage generating circuit 27 is not limited to this arrangement.

Each of the gradation display reference voltage generating circuits 27 includes two voltage input terminals, eight resistor elements R0 to R7, and the γ-correction adjustment circuits (a γ-correction adjustment section) 54. The eight resistor elements R0 to R7 have resistance ratios for performing γ-correction that is to be a standard. The voltage input terminals are a most-significant-voltage input terminal V0 and a least-significant-voltage input terminal V64. For γ-correction, the γ-correction adjustment circuits 54 respectively perform fine adjustment of the reference voltages obtained through the resistor elements R0 to R7. The fine adjustment is performed by increasing or decreasing the reference voltages within a certain range.

Furthermore, a total of 64 resistors (not shown), each eight of which are connected serially, are provided (i) between the most-significant-voltage input terminal VO and the γ-correction adjustment circuits 54, (ii) between output terminals of the γ-correction adjustment circuits 54, and (iii) between the output terminals of the γ-correction adjustment circuits 54 and the least-significant-voltage input terminal V64.

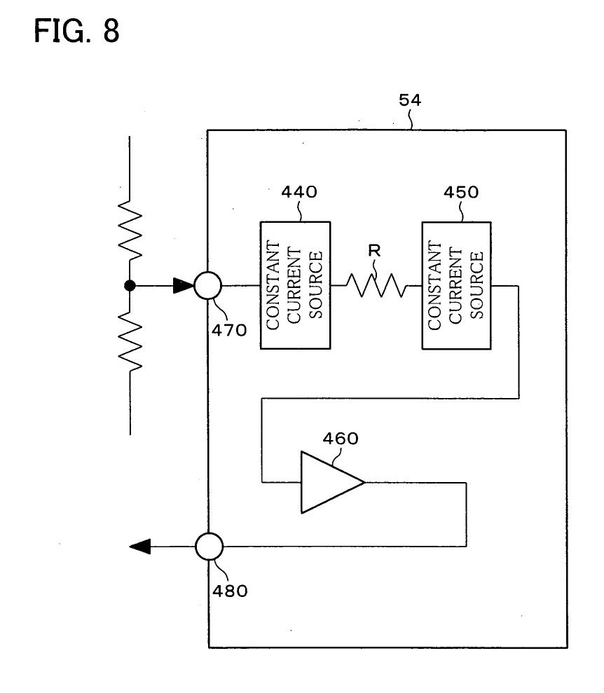

FIG. 8 is a schematic block diagram illustrating an arrangement of each γ-correction adjustment circuit 54. The γ-correction adjustment circuit 54 includes a resistor element R for causing a voltage drop, two constant current sources 440 and 450, and a buffer amplifier 460. The γ-correction adjustment circuit 54 adjusts an output voltage by shifting an input voltage up or down within a certain range by using a voltage drop caused when a current is applied to the resistor element R.

The γ-correction adjustment circuit 54 having the foregoing arrangement operates as follows. An input terminal 470 of the γ-correction adjustment circuit 54 receives a reference voltage Vref, for example. In order to obtain an output voltage that is higher or lower than the reference voltage Vref, the current on the resistor element R is changed by the constant current sources 440 and 450. Then, by using a voltage drop caused by the resistor element R, the input voltage is shifted up or down by an amount of the voltage drop, and is outputted as an output voltage Vout from an output terminal 480.

That is, in order to obtain an output voltage Vout higher than the reference voltage Vref, the γ-correction adjustment circuit 54 adjusts the voltage so as to satisfy Vout=Vref+i·R. In order to obtain an output voltage Vout lower than the reference voltage Vref, the γ-correction adjustment circuit 54 adjusts the voltage so as to satisfy Vout=Vref−i·R.

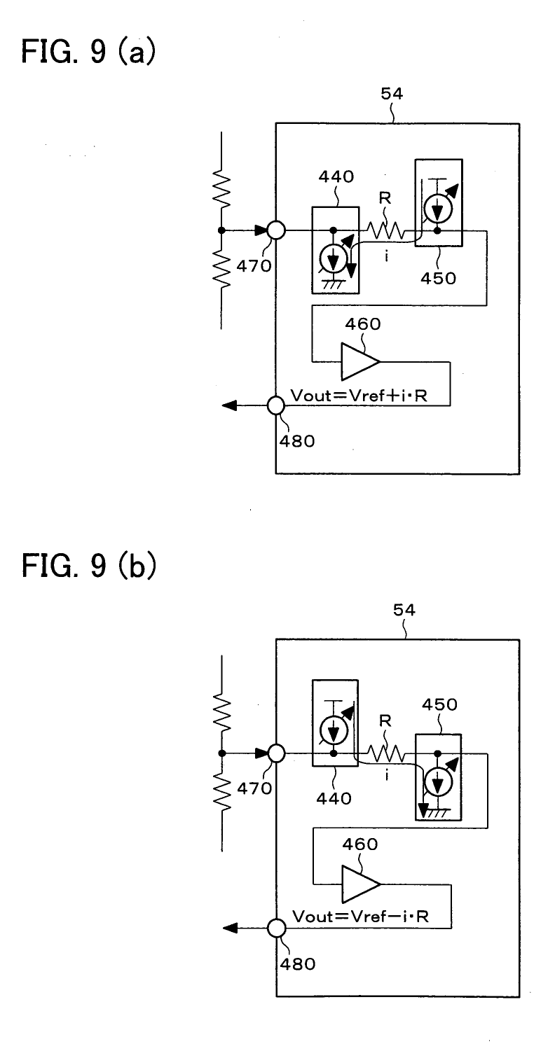

FIG. 9 illustrates how a current on the resistor element R is changed by operation of the constant current sources 440 and 450 in case an output voltage Vout higher than the reference voltage Vref is obtained (FIG. 9(a)), and in case an output voltage Vout lower than the reference voltage Vref is obtained (FIG. 9(b)).

In case of FIG. 9(a), the constant current source 440, which is provided between the input terminal 470 and the resistor element R, is grounded, and the constant current source 450, which is provided between the resistor element R and the output terminal 480, is connected to a power source. With this arrangement, a current i flows on the resistor element R in a positive direction from the constant current source 450 to the constant current source 440.

As a result, after the reference voltage Vref is supplied from the input terminal 470, an output voltage Vout from the output terminal 480 is Vout=Vref+i·R, which is higher than the reference voltage Vref by an amount of a voltage drop caused by the resistor element R.

On the other hand, if the constant current source 440 is connected to the power source, and the constant current source 450 is grounded, a current i flows on the resistor element R in a negative direction from the constant current source 440 to the constant current source 450. As a result, after the reference voltage Vref is supplied from the input terminal 470, an output voltage Vout from the output terminal 480 is Vout=Vref−i·R, which is lower than the reference voltage Vref by an amount of a voltage drop caused by the resistor element R.

Then, (1) the constant current sources 440 and 450 of the γ-correction adjustment circuits 54 are designed so that a current value can be switched to multiple values, (2) the constant current sources 440 and 450 are designed so that the one grounded and the one connected to the power source can be switched, and (3) the switching of (1) and (2) are controlled in accordance with the γ-correction adjustment data (H1r, H2G, and H3B). With this arrangement, it is possible to perform, for the γ-correction, fine adjustment of the reference voltages obtained through the resistor elements R0 to R7.

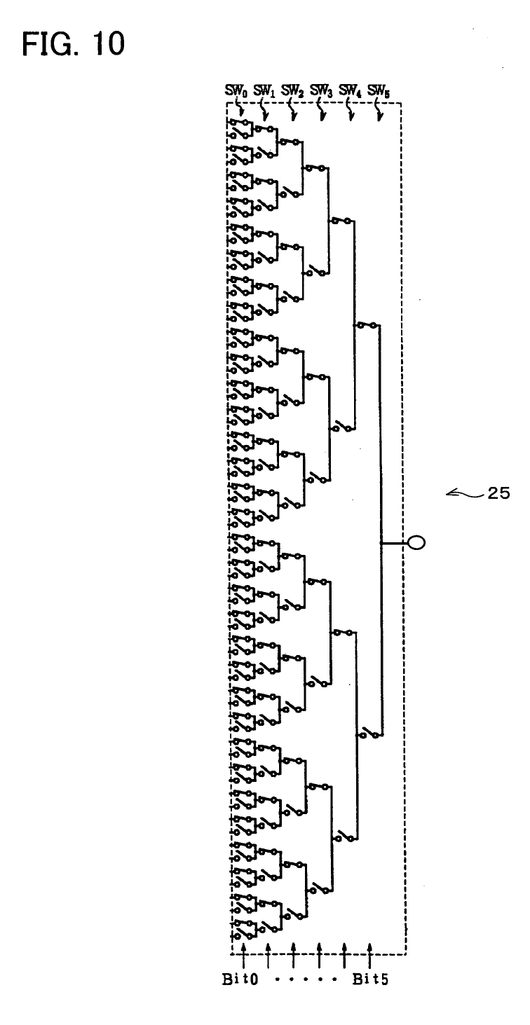

A voltage obtained by the fine adjustment, the voltage having an intermediate value between the reference voltages, are divided into eight voltages by eight of the 64 resistors, and are sent to the D/A converter circuit (see FIG. 1 and FIG. 10) 25.

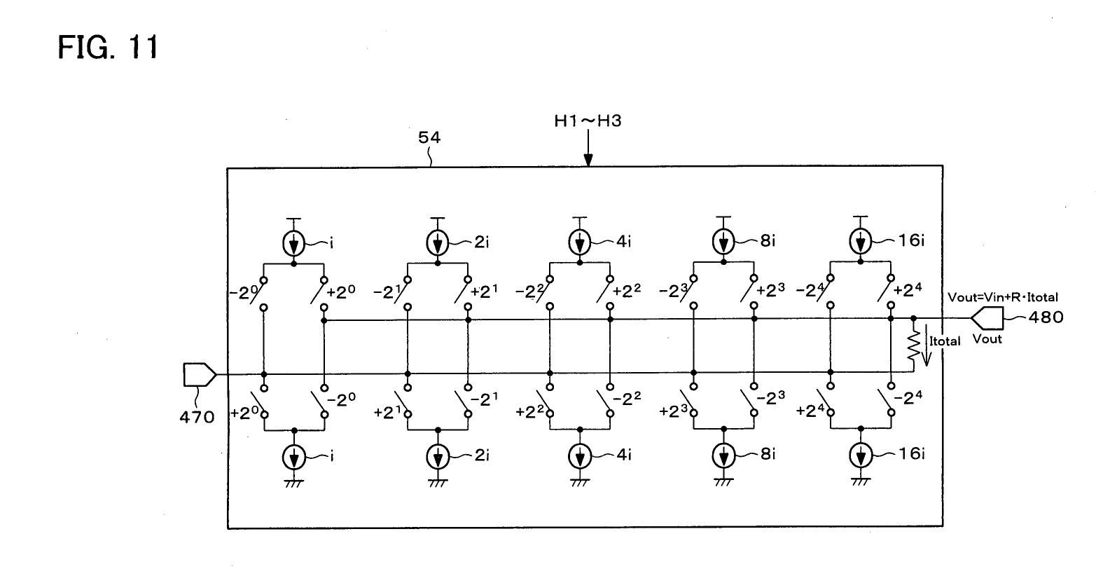

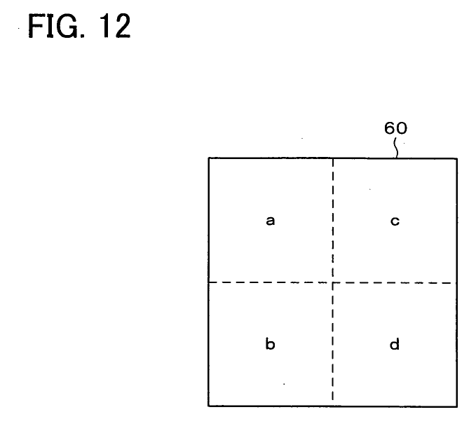

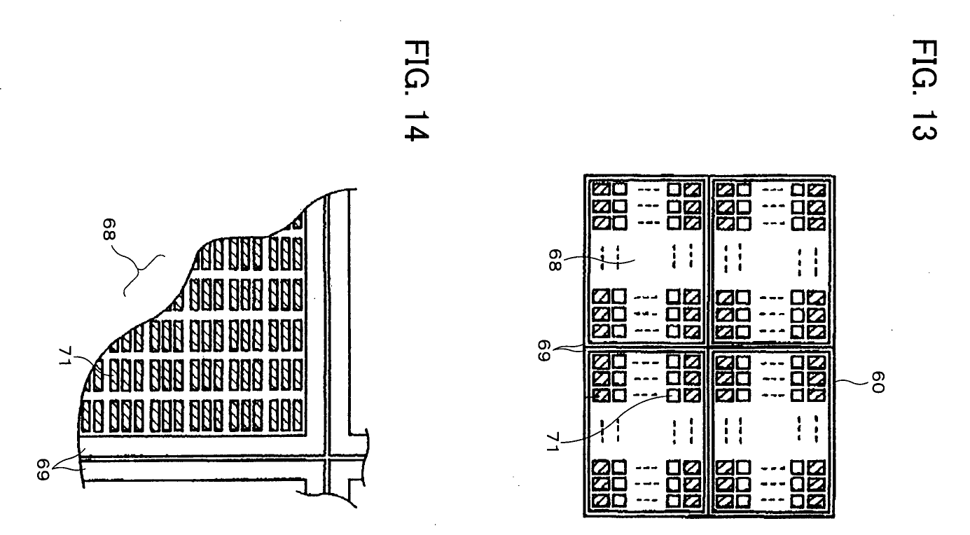

FIG. 11 illustrates a circuit arrangement of a constant current source section of the γ-correction adjustment circuit 54, the constant current source section realizing switching of current values and switching of grounding/connection to the power source with respect to the constant current source 440 and 450. The constant current source section includes five constant current sources i, 2i, 4i, 8i, and 16i that are connected to the power source, and that generate currents 2(n−1)i weighed by (n−1), where n is a positive integer. It is preferable that the constant current sources i, 2i, 4i, 8i, and 16i are shared by the reference voltages.

Each constant current source 2(n−1)i is connected to one end of the resistor element R and to the output terminal 480, via a switch +2⁽ⁿ⁻¹⁾, which turns ON in accordance with a +2⁽ⁿ⁻¹⁾ control signal. Furthermore, each constant current source 2(n−1)i is connected to the other end of the resistor element R and to the input terminal 470, via a switch −2⁽ⁿ⁻¹⁾, which turns ON in accordance with a −2⁽ⁿ⁻¹⁾ control signal.

Likewise, the constant current source section includes five constant current sources i, 2i, 4i, 8i, and 16i that are grounded, and that generate currents 2(n−1)i weighed by the (n−1). Each constant current source 2(n−1)i is connected to the other end of the resistor element R and to the input terminal 470, via the switch +2⁽ⁿ⁻¹⁾, which turns ON in accordance with the +2⁽ⁿ⁻¹⁾ control signal. Furthermore, each constant current source 2(n−1)i is connected to the one end of the resistor element R and to the output terminal 480 via the switch −2⁽ⁿ⁻¹⁾, which turns ON in accordance with the −2⁽ⁿ⁻¹⁾ control signal.

Thus, the constant current source 2(n−1)i connected to the input terminal 470 via the switch +2⁽ⁿ⁻¹⁾ and the resistor element R or via the switch −2⁽ⁿ⁻¹⁾ functions as the constant current source 440 in FIGS. 8 and 9. The constant current source 2(n−1)i connected to the output terminal 480 via the switch +2⁽ⁿ⁻¹⁾ and the resistor element R or via the switch −2⁽ⁿ⁻¹⁾ functions as the constant current source 450 in FIGS. 8 and 9.

By controlling ON/OFF of each switch +2⁽ⁿ⁻¹⁾ and −2⁽ⁿ⁻¹⁾ through the control circuit 6a in accordance with the γ-correction adjustment data (H1r, H2G, and H3B) stored in the display memory 7, it is possible to attain, with respect to the constant current sources 440 and 450, the switching of current values and the switching of grounding/connection to the power source.

With this arrangement, it is possible to change the value and direction of the current flowing on the resistor element R. Thus, it is possible to output such an output voltage Vout that is shifted up or down a plurality of stages by an amount of a voltage drop with respect to an input reference voltage Vin. The following provides a more specific example.

In the following, it is assumed that each of the γ-correction adjustment data (H1r, H2G, and H3B) is 6-bit data. If each of the γ-correction adjustment data is 6-bit data, it is possible to use 64 levels of −32 to +31 in performing adjustment of the γ-correction.

In FIG. 11, the constant current sources i, 2i, 4i, 8i, and 16i respectively generate current values i, 2i, 4i, 8i, and 16i that are weighed by 2(n−1). The switches +2⁽ⁿ⁻¹⁾ and the switches −2⁽ⁿ⁻¹⁾ turn ON or OFF in accordance with the adjustment data (H1r, H2G, and H3B). The following describes operation of the γ-correction adjustment circuit 54, the operation being in accordance with the 6-bit adjustment data.

In a first case, the adjustment data H1R is “+1: (000001)”. In this case, only two switches +2⁰ turn ON, and all the other switches turn OFF. This is the same situation as FIG. 9(a). That is, as in FIG. 9(a), a current Itotal is identical to the constant current i, and the direction of the current is positive.

Therefore, an output voltage Vout is higher than the input reference voltage Vin by an amount of a voltage drop caused by the resistor element R. As a result, the output voltage Vout is Vout=Vin+i·R. This is higher than the input voltage Vin by (i·R).

In another case, the adjustment data H3B is “−9: (101001)”. In this case, two switches −2³ and the two switches −2⁰ (a total of four switches) turn ON, and all the other switches turn OFF. This is the same situation as FIG. 9(b).

That is, as in FIG. 9(b), a current Itotal on the resistor element R is 9i, which is a sum of the constant current i and the constant current 8i, and the direction of the current is negative. Therefore, an output voltage Vout is lower than the input reference voltage Vin by an amount of a voltage drop caused by the resistor element R. As a result, the output voltage Vout is Vout=Vin−9i·R. This is lower than the input voltage Vin by nine times of (i·R).

In a case of yet another adjustment data, it is possible to perform voltage adjustment in 64 levels with a voltage of (i·R) per level within a range of −32 to +31 from the input reference voltage Vin by turning ON or OFF the switches +2⁽ⁿ⁻¹⁾ and −2⁽ⁿ⁻¹⁾, as in the foregoing operation.

That is, by using, as the adjustment data, multi-bit digital data in signed binary numbers in complementary notation on 2, it is possible to establish, through the switches +2⁽ⁿ⁻¹⁾ and −2⁽ⁿ⁻¹⁾, a one-to-one correspondence between the bit number n and the weight (magnification) 2(n−1) of a current value at the resistor element R.

This makes it possible to attain an amount of adjustment in which a magnification is determined in accordance with the adjustment data (H1R, H2G, and H3B). Thus, it is easy to specify the amount of adjustment of the reference values by using the adjustment data.

As described above, by turning ON/OFF the switches +2⁽ⁿ⁻¹⁾ and −2⁽ⁿ⁻¹⁾ in accordance with the γ-correction adjustment data H1R, H2G, and H3B stored in the display memory 7, it is possible to adjust input voltages in accordance with the adjustment data, and to output thus adjusted voltages. By performing this adjustment with respect to γ-correction values generated by the resistor elements R0 to R7, characteristics of liquid crystal driving output voltages can be changed upward or downward from the γ-correction values generated by the resistor elements R0 to R7.

The display memory 7 is such that, as need arises, the adjustment data can be rewritten feely by using a program or the like. Because the adjustment data can be rewritten, it is possible to change correction characteristics easily.

Thus, in case of a 64-gradation display, 64 kinds of gradation display voltages are generated and supplied to the D/A converter circuit 25. The D/A conversion circuit 25 selects, with respect to each pixel, one of 64 kinds of gradation display referential voltages in accordance with the display data supplied from the level shift circuit 24. Then, the D/A conversion circuit 25 supplies, to the output circuit 26, the gradation display referential voltages selected.

The output circuit 26 is a low-impedance conversion section including differential amplifiers and the like. The output circuit 26 respectively supplies, to a first to m-th source electrodes of the liquid crystal panel 2, the gradation display referential voltages selected by the D/A converter circuit 25.

The gradation display reference voltages are kept for one period of the horizontal synchronization signal H, i.e. one horizontal synchronization period. In a next horizontal synchronization period, gradation display reference voltages representative of new image data are outputted.

FIG. 7 illustrates one example of how γ-correction values are changed with respect to a borderline part (a joint part). For example, in the present embodiment, γ-correction values for a color B and a color R are changed. Here, a first source driver 3 performs γ-correction with respect to the color B. To the first source driver 3, an input signal BSI and a start signal SSPI (not shown), which are supplied from the controller 6, are supplied from the selecting circuit 27-4 associated with the B-use reference voltage generating circuit 27-3 of the gradation display reference voltage generating circuits 27.

A control signal BSO supplied from the selecting circuit 27-4 causes, to be conductive, the analog switch connected between the terminal H3 and the B-use reference voltage generating circuit 27-3. Then, the adjustment data H3B, which is for γ-correction of the B-color and which is stored in the display memory 7 in the controller 6, is supplied to the B-use reference voltage generating circuit 27-3, and correction of the gradation display reference voltage is performed.

On the other hand, a second source driver 3 performs γ-correction with respect to the R-color. To the second source driver 3, the input signal BSI and the start signal SSPI (not shown), which are supplied from the controller 6, are supplied from the selecting circuit 27-4 associated with the R-use reference voltage generating circuit 27-1.

A control signal RSO supplied from the selecting circuit 27-4 causes, to be conductive, the analog switch connected between the terminal H1 and the R-use reference voltage generating circuit 27-1. Then, the adjustment data H1R, which is for γ-correction of the R-color and which is stored in the display memory 7 in the controller 6, is supplied to the R-use reference voltage generating circuit 27-1, and correction of the gradation display reference voltage is performed.

The foregoing description refers to the first source driver 3 and the second source driver 3. However, this is only one example. The same applies to a case of a k-th source driver 3 and a (k+1)th source driver, where k is an integer that is not less than 1 and not more than a total number of the source drivers 3.

Each of the gate drivers 4 includes a shift register circuit, a level shift circuit, and an output circuit, which are not shown. In the gate driver 4, the shift register circuit receives the horizontal synchronization signal H and a vertical synchronization signal V. The vertical synchronization signal V is sequentially transferred through stages of the shift register circuit by using the horizontal synchronization signal H as a clock.

Outputs from the stages of the shift register circuit correspond to a first to n-th pixel in each column of the liquid crystal panel 2, that is, to a first to n-th gate electrodes. The shift register circuit performs level conversion of the outputs from the stages of the shift register circuit, so as to increase the outputs to such voltages that can control gates of the TFTs of the pixels. After the outputs from the stages are increased, the output circuit performs low-impedance conversion of the outputs, and supplies the outputs to the first to n-th gate electrodes of the liquid crystal panel 2. As scanning signals, the outputs from the gate driver 4 control ON/OFF of the TFTs of the pixels of the liquid crystal panel 2.

Thus, the scanning signals respectively select the gate electrodes, and turn ON the TFTs whose gates are connected to the gate electrodes. The gate electrodes are sequentially selected in each horizontal synchronization period, so that the pixels having the TFTs that are turned ON are sequentially moved in the vertical direction.

In the pixels that are selected by the scanning signals and thus turned ON, the gradation display voltages are supplied from the source electrodes to the pixel electrodes provided to the pixels. The pixel electrodes are charged in accordance with the voltages, and the voltages are kept in the pixel electrodes after the TFTs are turned OFF. In this way, the pixels perform gradation display.

In the foregoing description, the plurality of source drivers 3 are provided to the single liquid crystal panel 2. However, it is possible to improve display quality of a joint line in case a large screen is made by jointing a plurality of liquid crystal panels (in case characteristics of the plurality of liquid crystal panels are slightly different from one another).

As described above, according to the present embodiment, it is possible to independently change the γ-correction values by using the γ-correction adjustment data (H1R, H2G, and H3B) respectively supplied to the gradation display reference voltage generating circuits 27 (27-1 for R, 27-2 for G, and 27-3 for B) of the source drivers 3. Therefore, according to the present embodiment, it is possible to decrease the display unevenness, and to prevent the visual disadvantage of conventional displays that a joint line is visible. These effects are attained without requiring the conventional step of generating a complex-shape borderline on a liquid crystal panel. Therefore, according to the present embodiment, it is possible to provide a liquid crystal display device that can have a large screen and that can perform clear display.

In the foregoing description, the liquid crystal display device is described as one example of the display device. However, the present invention may be used for other display devices, as long as γ-correction is required. Examples of such other display devices are a CRT, a PDP (a plasma display) an EL (electroluminescence) display device, a light emitting diode display device, and the like. A γ-correction value may be changed in accordance with adjustment data determined by a user (adjuster), such as a viewing position, a viewing angle, and the like.

In order to solve the foregoing problems, a display device of the present invention includes: a display panel including a plurality of pixels provided in matrix in a first direction and in a second direction, the second direction intersecting with the first direction; a driving section for sequentially driving, in the second direction, each pixel line provided along the first direction, the driving section causing the display panel to display an image that is in accordance with display data; a reference voltage generating section for generating reference voltages that represent multiple gradations, the reference voltages being used for displaying the image in the multiple gradations; a γ-correction adjustment section for adjusting the reference voltages so as to perform γ-correction of the display data; and a control section for controlling the γ-correction adjustment section so as to change the reference voltages on which the γ-correction has been performed, the control section decreasing display unevenness between pixels that are adjacent to one another in at least one of the first and the second directions.

The display device may be arranged so that the control section includes a memory for storing γ-correction adjustment data, and the control section changes a γ-correction value in accordance with the γ-correction adjustment data.

The display device may be arranged so that the driving section includes a memory for storing γ-correction adjustment data, and the control section changes a γ-correction value in accordance with the γ-correction adjustment data.

According to the foregoing arrangements, by using the display panel, the driving section, the reference voltage generating section, and the γ-correction adjustment section, it is possible to display an image that matches a visual characteristic as a result of the γ-correction and that is expressed with gradations.

In the foregoing arrangement, the display device further includes the control section for controlling the γ-correction adjustment section so as to change the reference voltages on which the γ-correction has been performed. Therefore, even if there is display unevenness among pixels for reasons such as uneven quality of the pixels, the uneven quality deriving from a manufacturing process, it is possible to make the display unevenness less visible by changing the reference voltages.

In other words, according to the foregoing arrangement, it is possible to make the display unevenness less visible by changing the reference voltages, even if (i) the display panel is, for example, a large display panel made by bonding together a plurality of display panels so that display surfaces of the plurality of display panels are on the same plane, and (ii) display unevenness, such as uneven luminance, is generated due to uneven quality among the plurality of display panels, the uneven quality deriving from a manufacturing process.

With this arrangement, it is possible to decrease display unevenness, thereby preventing the visual disadvantage of conventional displays that joint lines are visible. This is achieved without requiring a conventional step of generating a complex-shape borderline on a liquid crystal panel. As a result, according to the foregoing arrangement, it is possible to provide a liquid crystal display device that can have a large screen and that can perform clear display.

The display device may be arranged so that the display panel is divided into a plurality of display regions aligned in the first direction; and the driving section includes a plurality of drivers for driving the plurality of display regions respectively.

With this arrangement, even if the plurality of drivers have different characteristics, the display unevenness that derives from the different characteristics can be decreased by changing the reference voltages.

The display device may be arranged so that the reference voltage generating section includes a plurality of reference voltage generating circuits that are respectively for colors used for performing color display of the image. With this arrangement, display unevenness generated in case of color display can be decreased.

The display device may be arranged so that the display panel includes a plurality of separate display panels provided in a surface direction of the display panel. With this arrangement, even if, for example, the display panel has a large display screen by including a plurality of separate display regions provided in the surface direction of the display panel, display unevenness that derives from a fact that the display panel includes the plurality of separate display panels can be decreased by changing the reference voltages.

The display device may be arranged so that the display panel includes a plurality of small display panels that are bonded together so that display screens of the plurality of small display panels are on a same plane. With this arrangement, even if, for example, the display panel has a large screen by including the plurality of small display panels that are bonded together so that the display screens of the plurality of small display panels are on the same plane, display unevenness that derives from a fact that the display panel include the plurality of small display panels can be decreased by changing the reference voltages.

The display device may be arranged so that the display panel includes: a thin-film transistor panel including (i) a plurality of pixel electrodes and (ii) thin-film transistors respectively for the plurality of pixel electrodes; and an opposed panel on which opposed electrodes are provided; and the thin-film transistor panel and the opposed panel are provided in an overlapping manner so that an electrode formation surface (a surface on which the plurality of pixel electrodes are provided) of the thin-film transistor panel and an electrode formation surface (a surface on which the opposed electrodes are provided) of the opposed panel face one another.

The display panel may be arranged so that the display panel includes: a plurality of thin-film transistor panels, each of which includes (i) a plurality of pixel electrodes and (ii) thin-film transistors respectively for the plurality of pixel electrodes; and an opposed panel on which opposed electrodes are provided; the plurality of thin-film transistor panels are bonded together so that display screens of the plurality of thin-film transistor panels are on a same plane; and the plurality of thin-film transistor panels and the opposed panel are provided in an overlapping manner so that an electrode formation surface (a surface on which the plurality of pixel electrodes are provided) of the plurality of thin-film transistor panels and an electrode formation surface (a surface on which the opposed electrodes are provided) of the opposed panel face one another.

As is clear from the foregoing description, the present invention makes it possible to independently change a γ-correction value with respect to display regions provided with no space between adjacent display regions. Therefore, it is possible to finely adjust display quality of the display device.

Because the present invention makes it possible to finely adjust the display quality and to decrease line-shaped display unevenness that conventionally appears at a joint part between adjacent display regions, it is possible to prevent the visual disadvantage, thereby attaining a clearer display screen. In addition, because the conventional step of generating a complex-shape borderline on a liquid crystal panel is not required, it is possible to prevent cost increase.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

What is claimed is:

1. A display device, comprising:
a display panel including a plurality of pixels provided in matrix in a first direction and in a second direction, the second direction intersecting with the first direction;
a driving section for sequentially driving, in the secbnd direction, each pixel line provided along the first direction, the driving section causing the display panel to display an image that is in accordance with display data;
a reference voltage generating section for generating reference voltages that represent multiple gradations, the reference voltages being used for displaying the image in the multiple gradations;
a γ-correction adjustment section for adjusting the reference voltages so as to perform γ-correction of the display data; and
a control section for controlling the γ-correction adjustment section so as to change the reference voltages on which the γ-correction has been performed, the control section decreasing display unevenness between pixels that are adjacent to one another in at least one of the first and the second directions.

2. A display device as set forth in claim 1, wherein:
the control section includes a memory for storing γ-correction adjustment data; and
the control section changes a γ-correction value in accordance with the γ-correction adjustment data.

3. A display device as set forth in claim 1, wherein:
the driving section includes a memory for storing γ-correction adjustment data; and
the control section changes a γ-correction value in accordance with the γ-correction adjustment data.

4. The display device as set forth in claim 1, wherein:
the display panel is divided into a plurality of display regions aligned in the first direction; and
the driving section includes a plurality of drivers for driving the plurality of display regions respectively.

5. The display device as set forth in claim 1, wherein:
the reference voltage generating section includes a plurality of reference voltage generating circuits that are respectively for colors used for performing color display of the image.

6. The display device as set forth in claim 1, wherein:
the display panel includes a plurality of separate display panels provided in a surface direction of the display panel.

7. The display device as set forth in claim 1, wherein:
the display panel includes a plurality of small display panels that are bonded together so that display screens of the plurality of small display panels are on a same plane.

8. The display device as set forth in claim 1, wherein:
the display panel includes:
a thin-film transistor panel including (i) a plurality of pixel electrodes and (ii) thin-film transistors respectively for the plurality of pixel electrodes; and
an opposed panel on which opposed electrodes are provided; and
the thin-film transistor panel and the opposed panel are provided in an overlapping manner so that an electrode formation surface of the thin-film transistor panel and an electrode formation surface of the opposed panel face one another.

9. The display device as set forth in claim 1, wherein:
the display panel includes:
a plurality of thin-film transistor panels, each of which includes (i) a plurality of pixel electrodes and (ii) thin-film transistors respectively for the plurality of pixel electrodes; and
an opposed panel on which opposed electrodes are provided;
the plurality of thin-film transistor panels are bonded together so that display screens of the plurality of thin-film transistor panels are on a same plane; and
the plurality of thin-film transistor panels and the opposed panel are provided in an overlapping manner so that an electrode formation surface of the plurality of thin-film transistor panels and an electrode formation surface of the opposed panel face one another.
